(19) United States
(12) Patent Application Publication
(10) Pub. No.: US 2014/0322521 A1
(43) Pub. Date: Oct. 30, 2014

(54) ADHESIVE STRUCTURE AND SURFACE TREATMENT FOR ADHESION

(71) Applicant: HON HAI PRECISION INDUSTRY CO., LTD., New Taipei (TW)

(72) Inventor: MING-JEN CHANG, New Taipei (TW)

(73) Assignee: HON HAI PRECISION INDUSTRY CO., LTD., New Taipei (TW)

(21) Appl. No.: 14/258,108

(22) Filed: Apr. 22, 2014

(30) Foreign Application Priority Data
Apr. 25, 2013 (TW) 102114769

(51) Int. Cl. C09J 9/00; C09J 133/20; C09J 7/02

(52) U.S. Cl. CPC C09J 9/00; C09J 7/02; C09J 133/20
USPC 428/327; 428/354; 524/502

(57) ABSTRACT

A high-strength but non-permanent adhesive structure includes an adhering member, a surface treatment layer, and an adhesive layer. The surface treatment layer is sandwiched between the adhering member and the adhesive layer. The surface treatment layer includes a plurality of expansion particles. The expansion particles are configured to expand at a predetermined temperature equal to or higher than a softening temperature thereof, such that an adhesive strength between the adhering member and the adhesive layer is decreased and adhered pieces can be easily separated. A surface treatment agent is used for making the adhesive structure.

### FIELD

The present disclosure relates to adhesive structures, and particularly to an adhesive structure which has a high adhesive strength and can be easily separated, and a surface treatment agent used for making the adhesive structure.

### BACKGROUND

Adhesive is used for adhering two workpieces together. Usually, a high adhesive strength is employed for strongly adhering the two workpieces, and an easy peeling ability is employed for easily separating the two workpieces from each other.

### BRIEF DESCRIPTION OF THE DRAWING

The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 illustrates a cross-sectional view of a first embodiment of an adhesive structure including the plurality of expansion particles.

FIG. 2 illustrates a cross-sectional view of a first embodiment of an expansion particle.

FIG. 3 is similar as FIG. 1, but showing the plurality of the expansion particles expanded after heating.

### DETAILED DESCRIPTION

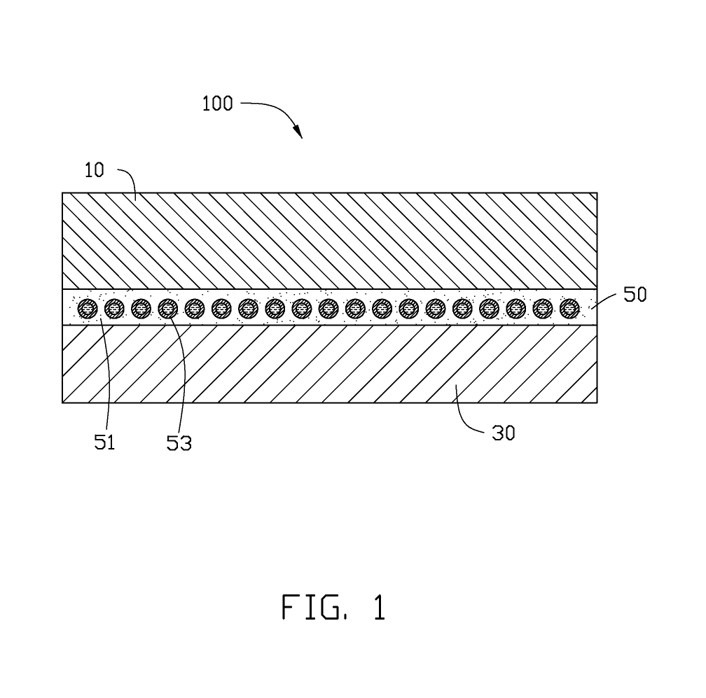

FIG. 1 shows a first embodiment of an adhesive structure 100 including an adhering member 10, an adhesive layer 30, and a surface treatment layer 50 sandwiched between the adhering member 10 and the adhesive layer 30. In the illustrated embodiment, the adhering member can be a metallic plate. In other embodiments, the structure and material of the adhering member can be changed as needed. For example, the adhering member can be a glass substrate. The adhesive layer 30 is formed by coating adhesive on the surface treatment layer 50, so that the adhering member 10 adheres to another workpiece (not shown).

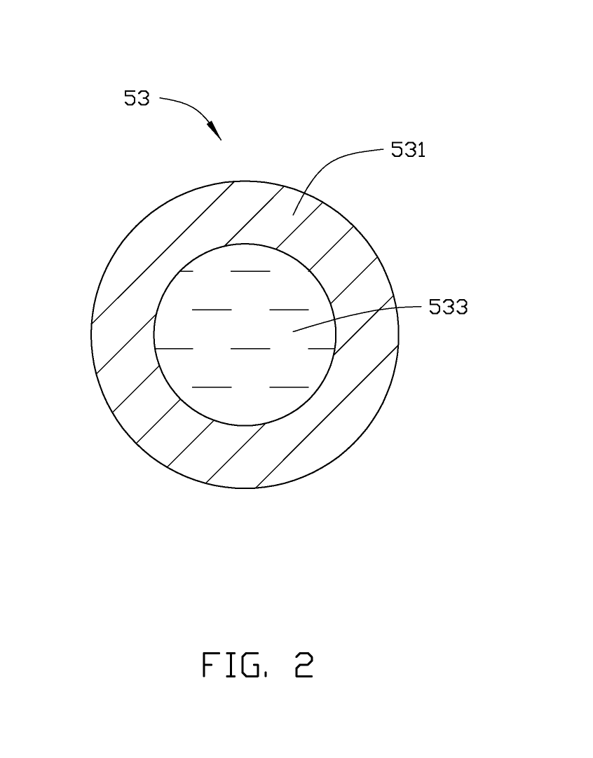

Referring also to FIG. 2, the surface treatment layer is formed by coating a surface treatment agent on the adhering member, for enhancing adhesive strength between the adhering member and the adhesive layer. The surface treatment layer reduces adhesive strength when the adhering structure is heated, for peeling the adhesive layer from the adhering member conveniently. The surface treatment layer includes a resin body and a plurality of expansion particles dispersed in the resin body, and a weight ratio of the particles 53 to the resin is in a range from 1 to 200.

Each expansion particle includes a shell 531 and a core 533 encapsulated in the shell 531, and a diameter of each expansion particle is in a range from 5 microns to 30 microns. The shell 531 is elastic, expanding its volume when heated to a predetermined temperature which is higher than or equal to a softening temperature of the shell 531. The shell 531 is made of materials selected from the group consisting of vinylidene chloride acrylonitrile copolymer, polyvinyl alcohol, polyvinyl butyral, polymethyl methacrylate, polyacrylonitrile copolymers, polyvinylidene chloride, and polysulfone. In the illustrated embodiment, the predetermined temperature is in a range from 80 to 140 degrees Celsius. The volume of the core 533 increases when the shell 531 is heated, thus the shell 531 expands further. The core 533 is made of materials selected from the group consisting of isobutene, propane, and pentane.

In other embodiments, the material of the shell 531 can be other types of material, so long as the shell 531 can encapsulate the core 533 and is elastic for expanding to increase its volume when heated. The material of the core 533 can also be other types of material, so long as the core 533 can expand to increase its volume when heated.

The surface treatment agent includes expansion particles, resin, and solvent. The resin is dissolved in the solvent. The resin can be one of acrylic resin, silicone, or rubber-based resin. In other embodiments, the resin can be other types of resin, as long as the resin is capable of enhancing the adhesive strength. The expansion particles are dispersed in the solvent. The solvent can be one or more typical organic solvents such as ethyl acetate, acetone, or butanone. In other embodiments, the solvent can be other types of typical organic solvent, so long as the solvent can dissolve the resin. The solvent can also be omitted when the expansion particles 53 are directly dispersed in the resin.

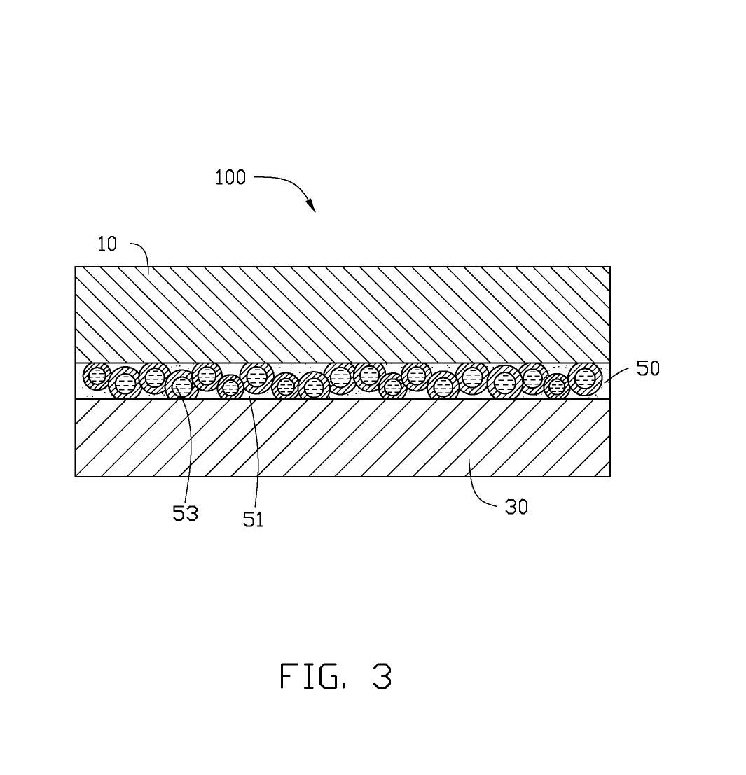

Referring also to FIG. 3, in the illustrated embodiment, because the surface treatment layer 50 includes the expansion particles, when the adhesive structure is heated to the predetermined temperature, the shell of each expansion particle received in the surface treatment layer 50 softens and expands, increasing the volume of the core, and thus leading the shell to expand further.

To illustrate how the predetermined temperature, and the heating time can adjust the adhesive strength in a peeling process (of the surface treatment layer 50 from the adhesive structure 100), seven examples are listed in table 1 below.

TABLE 1
A table of the predetermined temperature, the heating
time, and the adhering strength of the seven examples

| | Predetermined | | Adhesive |
|---|---|---|---|
| | temperature | Heating time | strength |
| Example | (degrees Celsius) | (minutes) | (N/25 mm) |
| Example 1 | 90 | 1 | 24.70 |
| Example 2 | 90 | 3 | 20.09 |
| Example 3 | 90 | 5 | 17.64 |
| Example 4 | 100 | 3 | 17.44 |
| Example 5 | 110 | 3 | 10.00 |
| Example 6 | 120 | 1 | 7.84 |
| Example 7 | 120 | 3 | 5.29 |

In the seven examples, the shell is made of polyacrylonitrile copolymers, and the core is made of pentane. Table 1 above shows that when the material of the expansion particles are same as each other, the higher predetermined temperature and the longer heating time decreases the adhesive strength of the adhesive layer.

While the present disclosure has been described with reference to particular embodiments, the description is illustrative of the disclosure and is not to be construed as limiting the disclosure. Therefore, those of ordinary skill in the art can make various modifications to the embodiments without departing from the true spirit and scope of the disclosure, as defined by the appended claims.

What is claimed is:

1. An adhesive structure comprising:
an adhering member;
an adhesive layer; and
a surface treatment layer sandwiched between the adhering member and the adhesive layer, wherein the surface treatment layer comprises a plurality of expansion particles dispersed from each other, the plurality of expansion particles are configured to expand at a predetermined temperature which is higher than or equal to a softening temperature of the expansion particles, and thus decreasing an adhesive strength between the adhesive layer and the surface treatment layer.

2. The adhering structure of claim 1, wherein each of the plurality of expansion particles comprises an elastic shell and a core encapsulated in the elastic shell, the shell and the core both are configured to expand at the predetermined temperature, wherein an expansion of the core causes the shell to expand further, thereby decreasing the adhesive strength between the adhesive layer and the surface treatment layer.

3. The adhering structure of claim 2, wherein the shell is made of one or more materials selected from the group consisting of vinylidene chloride acrylonitrile copolymer, polyvinyl alcohol, polyvinyl butyral, polymethyl methacrylate, polyacrylonitrile copolymers, polyvinylidene chloride, and polysulfone.

4. The adhering structure of claim 3, wherein the shell is made of acrylonitrile copolymer, and the plurality of expansion particles are configured to expand at the predetermined temperature which is in a range from 90 to 120 degrees Celsius.

5. The adhering structure of claim 2, wherein the core is made of one or more materials selected from the group consisting of isobutene, propane, and pentane.

6. The adhering structure of claim 2, wherein the surface treatment layer further comprise a resin body, and the plurality of expansion particles are dispersed in the resin body.

7. The adhering structure of claim 2, wherein a weight ratio of the plurality of expansion particles to the resin body is in a range from 1 to 200.

8. The adhering structure of claim 1, wherein a diameter of each expansion particle is in a range from 5 microns to 30 microns.

9. A surface treatment agent comprising:
a resin; and
a plurality of expansion particles dispersed in the resin, wherein each expansion particle are configured to expand at the predetermined temperature which is higher than or equal to a softening temperature of the expansion particles.

10. The surface treatment agent of claim 9, wherein each of the plurality of expansion particles comprises an elastic shell and a core encapsulated in the elastic shell, the shell and the core are both configured to expand at the predetermined temperature which is higher than or equal to a softening temperature thereof, wherein an expansion of the core causes the shell to expand further, thereby decreasing the adhesive strength between the adhesive layer and the surface treatment layer.

11. The surface treatment agent of claim 10, wherein the shell is made of one or more materials selected from the group consisting of vinylidene chloride acrylonitrile copolymer, polyvinyl alcohol, polyvinyl butyral, polymethyl methacrylate, polyacrylonitrile copolymers, polyvinylidene chloride, and polysulfone.

12. The surface treatment agent of claim 11, wherein the shell is made of acrylonitrile copolymer, and the plurality of expansion particles are configured to expand at the predetermined temperature which is in a range from 90 to 120 degrees Celsius.

13. The surface treatment agent of claim 10, wherein the core is made of one or more materials selected from the group consisting of isobutene, propane, and pentane.

14. The surface treatment agent of claim 9, wherein a weight ratio of the plurality of expansion particles to the resin is in a range from 1 to 200.

15. The surface treatment agent of claim 9, wherein a diameter of each expansion particle is in a range from 5 microns to 30 microns.

16. A surface treatment agent comprising:
a solvent;
a resin dispersed in the solvent; and
a plurality of expansion particles dispersed in the solvent, wherein each expansion particle is configured to expand at the predetermined temperature which is higher than or equal to a softening temperature of the expansion particles.
